(19) United States
(12) Patent Application Publication
(10) Pub. No.: US 2006/0284027 A1
(43) Pub. Date: Dec. 21, 2006

(54) Anti-vibration locking device for pipe and cable clamps

(75) Inventors: William J. Smith, Kirkland (CA); Alain Michaud, St-Jean sur Richelieu (CA); Daniel Lalancette, St-Jean sur Richelieu (CA)

Correspondence Address: HOFFMAN & BARON, LLP, 6900 JERICHO TURNPIKE, SYOSSET, NY, 11791, US

(73) Assignee: Thomsa & Betts International, Inc.

(21) Appl. No.: 11/397,986

(22) Filed: Apr. 4, 2006

Related U.S. Application Data
(60) Provisional application No. 60/668,133, filed on Apr. 4, 2005.

(51) Int. Cl. F16L 3/08

(52) U.S. Cl. 248/65

(57) ABSTRACT

The present invention provides a clamp body having a transverse surface and a threaded opening therein, a threaded bolt threaded through the opening, the bolt having a head at one end region and a saddle at an opposite end region, the saddle configured to clamp against a pipe, a locknut threaded on the bolt, the locknut adapted to being rotated on the bolt against the head with a predetermined amount of torque, the predetermined amount corresponding with a pre-determined force to be applied by the saddle against the pipe.

### CROSS-REFERENCE TO RELATED APPLICATIONS

This application claims the benefit of U.S. Provisional Application No. 60/668,133 filed on Apr. 4, 2005, entitled “Anti-Vibration Locking Device for Pipe and Cable Clamps”.

### FIELD OF THE INVENTION

This invention pertains to an improved pipe and cable clamp for more efficiently and effectively securing a pipe, cable or conduit to a support structure. The present invention provides a locknut and bolt clamping system wherein a predetermined bias is imparted by the clamp and wherein the clamp is also designed to maintain this optimal pressure against the pipe, clamp or conduit. Such features are especially important with jacketed cables where the jacket could be pierced or damaged if over-tightened, thereby compromising the integrity of the cable.

### BACKGROUND OF THE INVENTION

The use of pipe clamps to attach or fasten pipes or conduit to support structures is well known in the art. Such clamps typically include a saddle affixed to a threaded bolt that is in turn supported from a bracket mounted on the support structure. In operation, as the bolt is advanced, the saddle is moved to engage the pipe and force the pipe against the structural member, thereby securing the pipe to the structural member.

However, when using clamps that employ threaded bolts, it becomes readily apparent that different installers apply different forces or torque when compressing the pipe between the saddle and the structural member. Thus, if too much torque is applied by the installer, the pipe and clamp are over-pressurized and thus subject to deformation or breakage. On the other hand, if too little torque is applied, vibration in the pipe or support member may cause the bolt to loosen thereby effectively eliminating any restraining forces on the pipe at that clamping location. Such a situation will result in even greater pipe vibration or movement at adjacent clamp locations thereby subjecting these adjacent clamps to the same, if not greater, debilitating forces and hence hastening their failure as well.

Another liability when using threaded pipe clamps is that it is difficult to insure that proper torque has been applied. Testing for torque cannot be done visually and hence the inspector must instead physically test each pipe clamp bolt to ascertain whether the installation complies with local code or not. This is obviously not a workable solution or a best practice due to the number of pipe clamps being inspected and their oftentimes inaccessible location high above the floor. Thus, most inspections involve a simple visual check to make sure the saddle is against the pipe, not whether the saddle is properly pressed against the pipe at the specified torque.

Thus, it is desirable to provide a threaded bolt pipe clamp that allows the installer to secure a variety of different pipe sizes in place. It is also desirable to provide a pipe clamp that, once clamped in place, is not readily undone. Yet another object of this invention is to provide a means of applying uniform torque to the pipe no matter who installs same. Still another object of this invention is to provide a means whereby an inspector can visually ascertain whether the clamp has been properly installed and torqued. These and other objects and advantages will become apparent upon further investigation.

### SUMMARY OF THE INVENTION

The present invention therefore provides a clamp body having a transverse surface and a threaded opening therein, a threaded bolt threaded through the opening, the bolt having a head at one end region and a saddle at an opposite end region, the saddle configured to clamp against a pipe, a locknut threaded on the bolt, the locknut adapted to being rotated on the bolt against the head with a predetermined amount of torque, the predetermined amount corresponding with a pre-determined force to be applied by the saddle against the pipe.

The present invention further provides a method of assembling a pipe clamp against a pipe comprising the steps of: assembling a pipe clamp onto a support member in preparation for clamping the pipe clamp against the pipe, the pipe clamp comprising a transverse surface, a threaded bolt extending through an opening in the transverse surface, the bolt having a head at one end region and a saddle at an opposite end region configured to clamp against the pipe, and a locknut threaded on the bolt, the locknut being rotated on the bolt with a predetermined amount of torque, the predetermined amount corresponding with a pre-determined force to be applied by the saddle against the pipe, engaging the locknut and rotating the locknut with respect to the transverse surface until the saddle engages the pipe, applying a torque to the locknut, and thereby biasing the saddle against the pipe, until the locknut is released from the head, rotating the locknut along the bolt until engaging the transverse surface; and, tightening the locknut against the transverse surface to lock the bolt in place.

### BRIEF DESCRIPTION OF THE DRAWINGS

FIG. 1 is a perspective view of the clamp according to the present invention showing the pipe between the U-shaped member.

FIG. 2 is a top view of the pipe clamp according to the present invention attached to the support member.

FIG. 3 is a longitudinal right side view of the pipe clamp according to the present invention pressing the pipe against the support member.

FIG. 4 is a lateral side view of the pipe clamp according to the present invention pressing the pipe against the support member.

FIG. 5 is a longitudinal left side view of the pipe clamp according to the present invention pressing the pipe against the support member.

FIG. 6 is a lateral side view of the clamp according to the present invention before installation.

FIG. 7 is a lateral side view of the clamp according to the present invention after installation, and before the clamp presses the pipe against the support member.

FIG. 8 is a lateral side view of the clamp according to the present invention after installation, with the clamp pressing the pipe against the support member before securing the locknut.

FIG. 9 is a lateral side view of the clamp according to the present invention after installation, with the clamp pressing the pipe against the support member and with the locknut released from the bolt head.

FIG. 10 is a lateral side view of the clamp according to the present invention after installation, with the clamp pressing the pipe against the support member and with the locknut in the locking position.

FIG. 11 is a perspective view of a locknut for use with the present invention.

### DETAILED DESCRIPTION OF THE PREFERRED EMBODIMENT

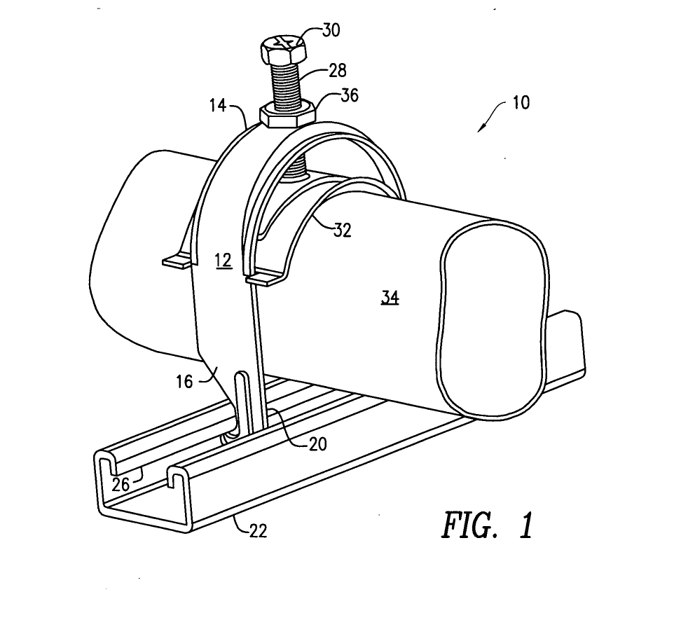

Referring initially to FIG. 1, there is a shown a pipe clamp 10 of typical construction incorporating an inverted U-shaped clamp body 12 having a transverse surface 14 and a pair of spaced-apart legs 16 depending therefrom. Intermediate legs 16 is pipe receiving location 18 while the distal end region 20 of each leg 16 is configured for attachment to a structural member 22, such as a strut as shown. In this regard, distal end region 20 may include hook-like ends 24 which are engageable with lip 26 of a conventional U-shaped strut 22. As shown, bolt 28 passes through a threaded opening in transverse surface 14 in the conventional fashion. One end region of bolt 28 is configured with a head 30 while a pipe engaging saddle 32 is affixed to the opposite end region. Obviously, as bolt 28 is rotated, saddle 32 is raised or lowered with respect to transverse surface 14. It is to be understood that the foregoing arrangement and/or construction may vary depending on the particular pipe clamp to be employed and/or size of pipe 34 to be clamped. It is also to be understood that this pipe clamp need not be limited to pipe only but can also be used to secure conduit, cable jacketed or unjacketed) or other objects to structural member 22.

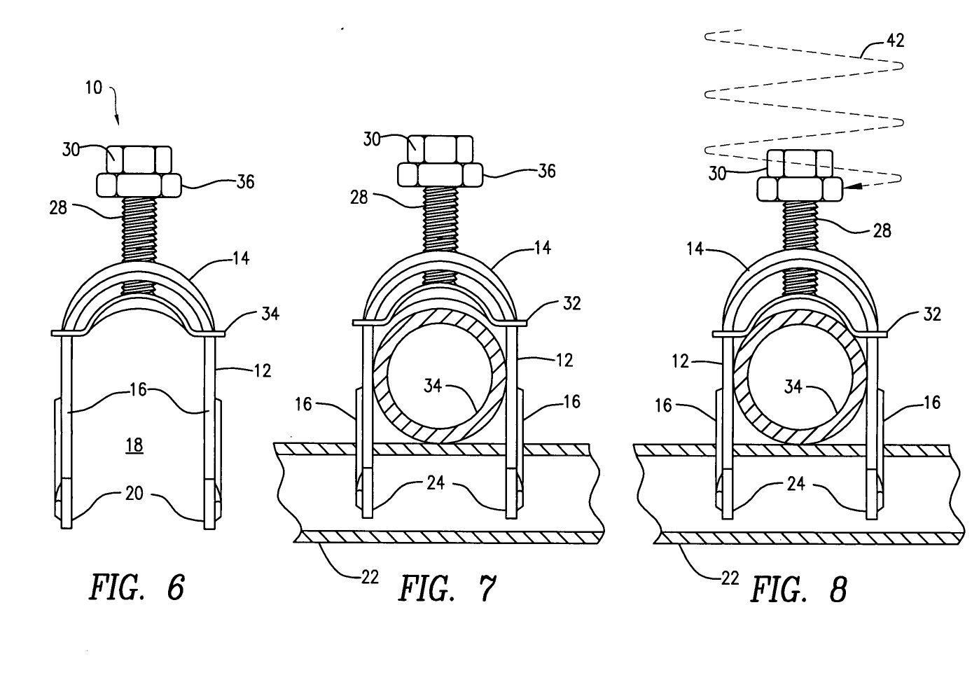

In the preferred embodiment, a locknut 36 is threaded onto bolt 28. In FIG. 1, this locknut 36 is shown abutting transverse surface 14 but as indicated in FIG. 6 and prior to installation, locknut 36 abuts head 30. Locknut 36 may be of typical construction and comprise nothing more than a simple common nut or locknut 36 may be specially configured with serrations 38 (FIG. 11) on one or both surfaces so as to better engage or grip the adjoining surface. Likewise, the underneath side of head 30 or the top surface of transverse surface 14 may also be roughened or contain serrations as may be desired. In any event, locknut 36 is preferably constructed with a series of flats surfaces 40 that permit locknut 36 to be engaged by a hand or power tool (not shown).

It is also to be noted and as readily shown in FIG. 6, locknut 36 has a greater nominal diameter size than that of head 30. This is so that the installer will engage locknut 36 with the tool used to rotate bolt 28 rather than engage head 30. The reason for the tool engagement of locknut 36 and not head 30 will be further explained and described hereinbelow.

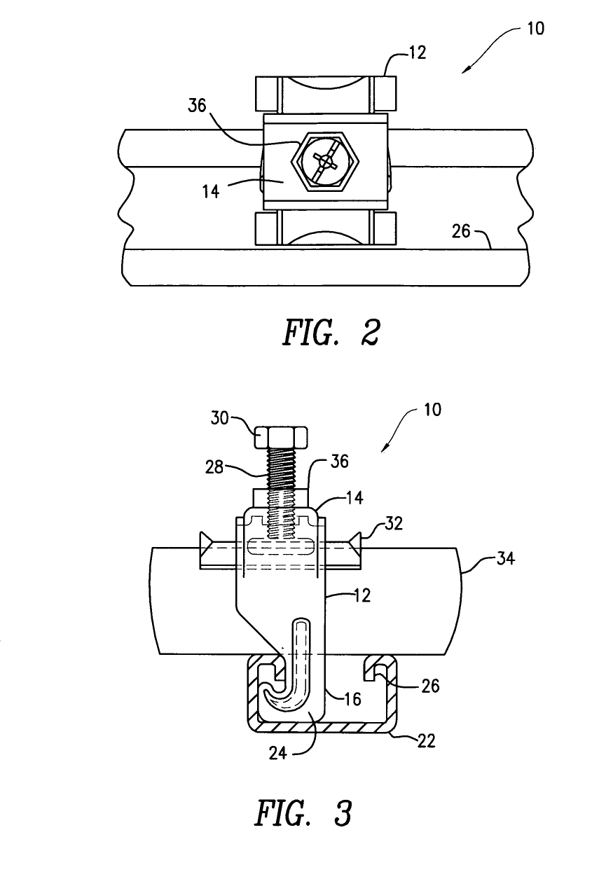

Turning now to FIG. 2, there is shown a top view of the pipe clamp attached to the structural member. In this view, the clamp 10 is positioned over the structural member, such that the hook like ends 24 of distal region 20 is in alignment and attached to lip 26 as seen in FIG. 1. Furthermore it can be seen that clamp 10 is offset to one side of structural member 22 such that it will engage the lip 26 that is adjacent to its location. It should be noted that the clamp 10 can be turned 180° in order to engage lip 26 on the opposite side of structural member 22. Also shown in FIG. 2 is the transverse surface 14 of U-shaped clamp body 12 and saddle 32, along with the head 30 of bolt 28 (not visible in this view). Furthermore, because the nominal diameter size of locknut 36 is greater than the nominal diameter size of head 30, the outline of locknut 36 is visible beyond the edge of head 30.

Turning now to FIG. 3 there is shown a longitudinal right side view of the pipe clamp 10 pressing the pipe 34 against the support member 22. As can be seen in this view, pipe 34 is in contact with structural member 22. The pipe 34 is held rigid against structural member 22 by saddle 32. Saddle 32 is positioned into contact with pipe 34 by bolt 28. Bolt 28 is a threaded bolt wherein the threads act as ramps to convert rotational motion of the bolt in the axial direction to translational motion of the bolt in the longitudinal direction. Therefore, by rotating bolt 28 in the clockwise direction, bolt 28 moves in a longitudinal direction whereby saddle 32 is positioned into contact with pipe 34. By continuing to rotate bolt 28 in the clockwise direction after contact with pipe 34 has occurred, a clamping force can be exerted on pipe 34 thereby rigidly clamping pipe 34 between structural member 22 and saddle 32. As will be further explained hereinbelow, once bolt 28 is fully tightened such that sufficient clamping force is imparted to pipe 34, locknut 36 is released from contact with bolt head 30 by the force exerted by a hand or power tool. Locknut 36 can then rotate on bolt 28 thereby bringing it into contact with the transverse surface 14 of U-shaped clamp 12. Tightening locknut 36 prevents bolt 28 from rotating and thereby releasing pressure upon saddle 32 due to vibration or movement of pipe 34 or structural member 22. Also visible in FIG. 3 is a cross sectional view of structural member 22 along line A-A of FIG. 1. In this view, structural member 22 can be seen to be of symmetrical design, such that lip 26 is visible on both sides of structural member 22. It can be seen in this view that hook like ends 24 of intermediate legs 16 are in engagement with lip 26 thereby providing a rigid connection below the pipe between the clamp 10 and structural member 22.

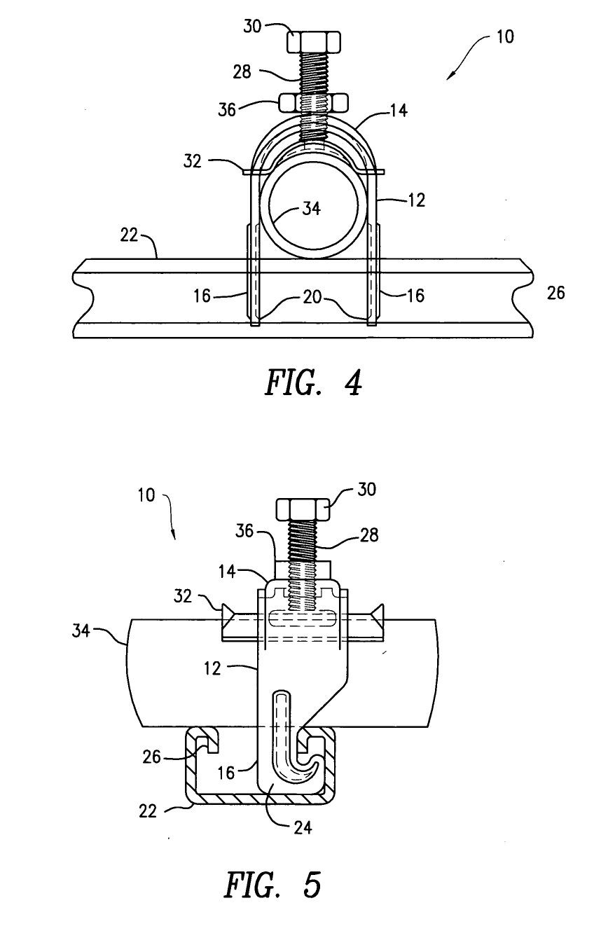

Turning now to FIG. 4 there is shown a lateral side view of the pipe clamp pressing the pipe against the support member. In this view, it can be seen that pipe 34 is held by U-shaped clamp 12 on its left and right side of this view, by structural member 22 on the bottom and against saddle 32 on the top. As previously explained the hook like ends 24 of intermediate legs 16 engage with lip 26 and provide bearing points against which clamp 10 can be held as saddle 32 is moved into contact with pipe 32 by rotating bolt 28 and thereby exerting a clamping force on pipe 34.

Turning now to FIG. 5 there is shown a longitudinal left side view of the pipe clamp 10 pressing the pipe 34 against the support member 22. This figure displays the pipe, clamp and structural member as seen in FIG. 3 from a 180 degree opposite view in the same plane. As in FIG. 3, pipe 34 is in contact with structural member 22. The pipe 34 is held rigid against structural member 22 by saddle 32. Saddle 32 is positioned into contact with pipe 34 by bolt 28. Bolt 28 is a threaded bolt wherein the threads act as ramps to convert rotational motion of the bolt in the axial direction to translational motion of the bolt in the longitudinal direction. Therefore, by rotating bolt 28 in the clockwise direction, bolt 28 moves in a longitudinal direction whereby saddle 32 is positioned into contact with pipe 34. By continuing to rotate bolt 28 in the clockwise direction after contact with pipe 34 has occurred, a clamping force can be exerted on pipe 34 thereby rigidly clamping pipe 34 between structural member 22 and saddle 32.

Turning now to FIG. 6-10, there is shown a sequence of clamp 10 being positioned on pipe 34 and engaging structural member 22. Once the hook like ends 24 engage lip 26 as shown in FIG. 7, pipe 34 is rigidly affixed to structural member 22 by the clamping force exerted by saddle 32 as further described below.

In accordance with this invention, locknut 36 is pre-torqued a certain amount up against the underneath side of head 30. This is desired so that during pipe clamp installation, as will be discussed in greater detail below, a certain corresponding force must be applied to locknut 36 in order to separate or release locknut 36 from bolt head 30. Until this corresponding release force is reached, bolt 28 will rotate with respect to transverse surface 14 thereby causing saddle 32 to move. However, once saddle 32 engages pipe 34, further rotation of bolt 28 will require the application of more force to locknut 36. The application of these increasing forces upon locknut 36 will continue until the release force is reached at which time locknut 36 will separate from head 30.

Tests have shown that the applied force (i.e. the pre-torque of locknut 36 against bolt head 30) has a generally linear relationship with respect to the release force (i.e. the force required to separate locknut 36 from bolt head 30). Of course, this relationship between the applied force and the release force is dependent upon many variables including temperature, material and the configuration of the two engaging surfaces and thus can be varied in accordance with a particular application or use of the present invention.

As is readily apparent, the application of these increasing forces upon locknut 36 corresponds directly with a greater and great pressure being applied by saddle 32 upon pipe 34. Hence, by controlling the torque applied by locknut 36 against head 30, the force or range of forces required to separate the two can also be determined or controlled. Thus, the release force will correlate closely to or equal the force saddle 32 applies to pipe 34. Another way of stating this is that the amount of force saddle 32 imparts upon pipe 34 is controlled by the amount of force necessary to release locknut 36 from head 30. This is because once locknut 36 is released, the continued application of force upon locknut 36 will cause locknut 36 to rotate further along bolt 28 rather than continue to increase the force applied by saddle 32 against pipe 34. When locknut 36 reaches transverse surface 14 it can be tightened against that surface to lock bolt 28 in place.

Consequently, where a standard or a local code specifies a set force or range of forces to be applied by a pipe clamp against a pipe or other such structure, this standard value can be achieved by biasing locknut 36 a corresponding amount in the opposite direction against head 30 in each such pipe clamp. Obviously, for consistency's sake or depending on the locknut release force desired, it may be necessary to employ a locknut 36 having serrations 38 or other type of grip enhancing or even grip releasing characteristic. In this vein, a separate body, such as a washer, having a known rotational grip strength can be employed between locknut 36 and head 30. Thus, once this grip strength is exceeded, the locknut will separate from the head as described herein.

Turning again to FIG. 6 clamp 10 is in its pre-installed position after locknut has been pre-torqued against head 30. Such pre-torquing is ideally accomplished during manufacture, but it is conceivable that locknut 36 can be field-torqued as well by an installer using a hand or power torque wrench. FIG. 7 shows clamp 10 affixed to member 22 with legs 16 positioned around pipe 34 and with saddle 32 spaced from pipe 34. The greater nominal diameter size of locknut 36 as compared with head 30 enables the user to engage locknut 36 with a socket or wrench or other tool (power or manual). Helical arrow 42 in FIG. 8 indicates the rotation of locknut 36 by the user to move saddle 32 so as to engage pipe 34. Of course, if desired, bolt 28 may have different threads thereby resulting in the rotation of locknut 36 in a different direction.

Prior to the engagement of saddle 32 with pipe 34, the rotational force applied by the user is nominal, i.e. simply that required to thread bolt 28 through transverse surface 14. However, once saddle 32 engages pipe 34, greater rotational forces are required since the pipe will resist further downward movement of saddle 32. The greater rotational forces applied to locknut 36 increase (all the while increasing the bias of saddle 32 against pipe 34) until such time that locknut 36 is released from head 30. This release force is, of course, dependent upon the amount of torque initially applied to set locknut 36 against head 30.

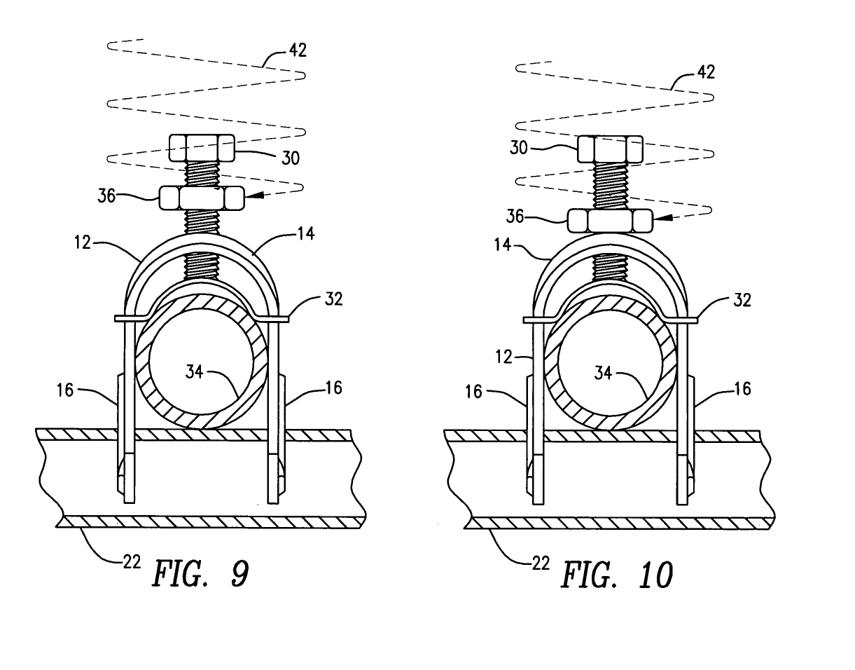

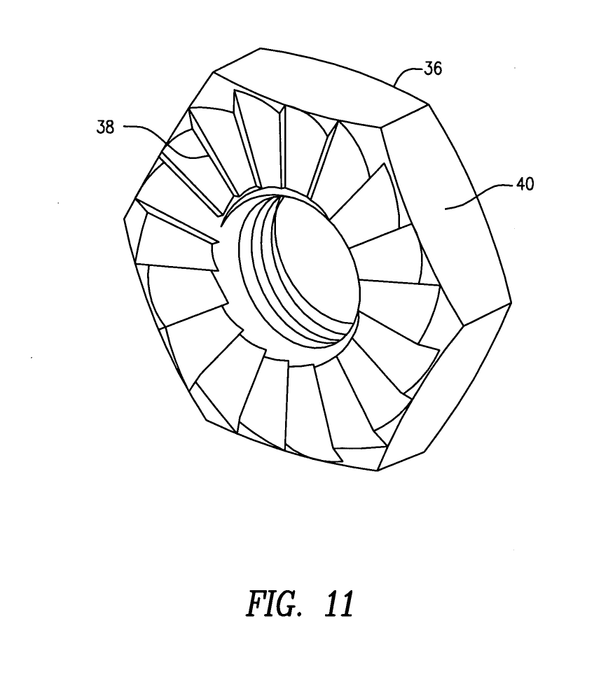

FIG. 9 illustrates the continued application of rotational forces upon locknut 36 after it is released from head 30. Locknut 36 rotates on the threads of bolt 28, thus moving longitudinally along bolt 28 while the bias of saddle 32 upon pipe 34 remains relatively unchanged from the time that locknut 36 was released. Locknut 36 continues to be rotated until it engages transverse surface 14 as shown in FIG. 10. At this point in time, the user will securely tighten locknut 36 against transverse surface 14 to thereby lock bolt 28 in place in the normal fashion. By such locking, the bias applied by saddle 32 upon pipe 34 will be preserved and maintained. Also, at each pipe clamp 10 location along pipe 34, the bias applied by saddle 32 upon pipe 34 will remain relatively consistent regardless of the installer just so long as the installer breaks locknut 36 from head 30 and thereafter tightens this locknut 36 against transverse surface 14.

As can thus be seen, when employing the present invention, a visual inspection of clamp 10 to insure that locknut 36 is pressed against transverse surface 14 will likewise insure that proper pressure is applied by saddle 32 against pipe 34. No further physical testing of clamp 10 is needed to insure that clamp 10 is properly installed, the inspector need only check to see that the locknut no longer abuts head 30 of bolt 28.

Turning now to FIG. 11, there is shown a typical locknut 36 according to the present invention. As previously described above, Locknut 36 maybe of typical construction and comprise nothing more than a simple common nut or locknut 36 may be specially configured with serrations 38 on one or both surfaces so as to better engage or grip the adjoining surface, in this case, transverse surface 14. Likewise, the underneath side of head 30 or the top surface of transverse surface 14 may also be roughened or contain serrations as may be desired. In any event, locknut 36 is preferably constructed with a series of flat surfaces 40 that permit locknut 36 to be engaged by a hand or power tool (not shown) and furthermore is of a nominal diameter size greater than that of bolt head 30.

While select preferred embodiments of this invention have been illustrated, many modifications may occur to those skilled in the art and therefore it is to be understood that these modifications are incorporated within these embodiments as fully as if they were fully illustrated and described herein.

What is claimed is:

1. A pipe clamp comprising:
a clamp body having a transverse surface and a threaded opening therein; a threaded bolt threaded through said opening, said bolt having a head at one end region and a saddle at an opposite end region, said saddle configured to clamp against a pipe;
a locknut threaded on said bolt, said locknut adapted to being rotated on said bolt against said head with a predetermined amount of torque, said predetermined amount corresponding with a pre-determined force to be applied by said saddle against the pipe.

2. The pipe clamp as set forth in claim 1 wherein at least a portion of said locknut extends beyond the circumference of said head.

3. The pipe clamp as set forth in claim 1 wherein said locknut is configured to be engaged by a tool.

4. The pipe clamp as set forth in claim 1 wherein said locknut is configured to be released from said head and subsequently torqued against said transverse surface.

5. The pipe clamp as set forth in claim 1 wherein said locknut or said head includes a grip enhancing surface on at least one side thereof.

6. The pipe clamp as set forth in claim 1 wherein a body having a known rotational grip strength is compressed between said locknut and said head.

7. A method of assembling a pipe clamp against a pipe comprising the steps of: assembling a pipe clamp onto a support member in preparation for clamping said pipe clamp against the pipe, said pipe clamp comprising a transverse surface, a threaded bolt extending through an opening in said transverse surface, said bolt having a head at one end region and a saddle at an opposite end region configured to clamp against the pipe, and a locknut threaded on said bolt, said locknut being rotated on said bolt with a predetermined amount of torque, said predetermined amount corresponding with a pre-determined force to be applied by said saddle against the pipe;
engaging said locknut and rotating said locknut with respect to said transverse surface until said saddle engages said pipe;
applying a torque to said locknut, and thereby biasing said saddle against the pipe, until said locknut is released from said head;
rotating said locknut along said bolt until engaging said transverse surface; and, tightening said locknut against said transverse surface to lock said bolt in place.

8. The method as set forth in claim 7 further comprising the step of configuring at least a portion of said locknut to extend beyond the circumference of said head.

9. The method as set forth in claim 7 further comprising the step of configuring said locknut to be engaged by a tool.

10. The method as set forth in claim 7 further comprising the step of configuring said locknut or said head to include a grip enhancing surface on at least one side thereof.

11. The method as set forth in claim 7 further comprising the step of compressing a body having a known rotational grip strength between said locknut and said head.
